(19) United States
(12) Patent Application Publication
(10) Pub. No.: US 2025/0080164 A1
(43) Pub. Date: Mar. 6, 2025

(54) Method and System for Crosstalk Prevention in Wired Communication Systems

(71) Applicants: James Armand Baldwin, Palo Alto, CA (US); Gladys Yuan Yan Wong, Fremont, CA (US); Hedley Davis, Middletown, DE (US); Peter Ian Macdonald, Redwood City, CA (US); Andrew Walters, Palo Alto, CA (US)

(72) Inventors: James Armand Baldwin, Palo Alto, CA (US); Gladys Yuan Yan Wong, Fremont, CA (US); Hedley Davis, Middletown, DE (US); Peter Ian Macdonald, Redwood City, CA (US); Andrew Walters, Palo Alto, CA (US)

(21) Appl. No.: 18/792,446

(22) Filed: Aug. 1, 2024

Related U.S. Application Data
(60) Provisional application No. 63/530,412, filed on Aug. 2, 2023.

(51) Int. Cl. H04B 3/32; H04B 3/54

(52) U.S. Cl. CPC H04B 3/32; H04B 3/54

(57) ABSTRACT

A system and method for preventing crosstalk in a wired communication system comprising multiple transmitters and multiple receivers, where each transmitter sends a low-frequency bus identification packet to the receivers to which it is galvanically connected, and where the low-frequency bus identification packet is structured so that it cannot be carried over into a neighboring wire by crosstalk.

### CROSS-REFERENCE TO RELATED APPLICATIONS

The present application takes priority from Provisional App. No. 63/530,412, filed Aug. 2, 2023, which is incorporated herein by reference.

### BACKGROUND

### Field of the Invention

The present invention relates broadly to crosstalk prevention in wired communication systems, and more particularly to crosstalk prevention in powerline carrier communication systems.

### Background

Crosstalk is a serious problem in any wired communication system. Broadly speaking, crosstalk is defined as the unwanted transmission of a signal from one wire to a neighboring wire via electric or magnetic field fluctuations. If both wires are carrying separate signals to separate devices, crosstalk can seriously interfere with the ability to control or communicate with either device.

This problem exists in multiple contexts, and is especially serious for powerline communication systems. In a powerline communication system, data is provided over a powerline supplying power to a device. Since this is by definition a wired system, if two wires are located near each other, crosstalk will arise.

U.S. Pat. No. 11,506,414 describes a low-voltage system and method of providing power and data signals to low-voltage fixtures located in a building, without the need for standard voltage wiring throughout the building. The application discloses a hub comprising a standard-voltage power input for supplying power to the system and a plurality of low-voltage outputs connected to low-voltage fixtures. Each low-voltage fixture (such as a light, a fan, a sensor, etc.) is configured to accept power and data input over the same connection. The hub also comprises a communication interface for communicating with a computing device such as a phone or a computer, and an application processor that can receive control signals through the communication interface and encode data signals in the power signals delivered via at least one of the output connections. This enables most of the wiring in the building to be low-voltage wiring, and only the hub being connected to standard-voltage wiring.

Unfortunately, the system disclosed in the abovenamed reference (like any powerline-carrier system) experiences crosstalk issues when two hubs are close to each other. If two wires carrying a signal are close to each other, the communications signals on their respective output lines can couple together, resulting in a device communicating with a hub that it is not physically connected to. This is not desirable, because the hub is only intended to communicate with the devices to which it is galvanically connected, for security and commissioning purposes.

A need exists for a method of preventing crosstalk between two wires located close together, wherein each wire carries both power and data signals.

### SUMMARY OF THE INVENTION

An object of the present invention is to provide a system and method for preventing crosstalk.

Another object of the present invention is to provide a system and method for pairing a transmitter and a receiver in a way that avoids crosstalk.

The method of the present invention prevents crosstalk in a system comprising a first transmitter connected to a first receiver and a second transmitter connected to a second receiver, wherein both connections are wired communication lines. The method involves scanning for a bus identification packet-a low-frequency short signal with a frequency of no more than 1 kHz, which comprises information for the transmitter that is sending it. Since the frequency of the bus identification packet is low, it is not transmitted by crosstalk, meaning that the only device that will receive it will be the one galvanically connected to the transmitter. The first receiver does not transmit or receive any information until it receives a bus identification packet; once it receives the bus identification packet from the first transmitter, it pairs with the first transmitter and only sends and receives data from that device.

In an embodiment, the bus identification packet comprises the MAC address for the first transmitter.

In an embodiment, the bus identification packet cannot be transmitted by crosstalk at all; in another embodiment, it is identifiably different from the original signal when it is transmitted by crosstalk. It may be a small perturbation of the voltage on a wired communication line; for example, it may be created by low frequency modulation of the voltage within a 5V range.

In an embodiment, a second receiver can also scan for a bus identification packet, receive a second bus identification packet from a second transmitter, and then pair with the second transmitter and only send and receive data from the second transmitter.

The bus identification packet may be sent once or more than once. In an embodiment, it is sent at regular intervals. In an embodiment, it is sent at any time a new receiver or transmitter is added.

In an embodiment, a third receiver is then added and galvanically connected to the first transmitter. It does not transmit or receive any data until it receives a third bus identification packet from the first transmitter. The third bus identification packet is a low frequency signal whose frequency is no more than 1 kHz and comprises identifying information for the first transmitter. Once the third bus identification packet is received by the third receiver, it is paired with the first transmitter and only sends and receives data from the first transmitter.

The system of the present invention comprises a first transmitter connected to a first receiver via a wired connection and a second transmitter connected to a second receiver via a second wired connection. Each receiver is configured to not send or receive any data until it receives a bus identification packet from the transmitter to which it is galvanically connected. The bus identification packet is a low-frequency signal whose frequency is no more than 1 kHz and comprises identifying information for a transmitter that sends it. Each receiver is configured to pair with any transmitter that sends a bus identification packet to that receiver, and then only sends and receives information from that transmitter.

The wired connections may be powerline communication system connections and the transmitters may be powerline communication hubs.

### LIST OF FIGURES

FIG. 1 shows a block diagram of an embodiment of a system of the present invention.

FIG. 2 shows a flowchart of an embodiment of a method of the present invention.

FIG. 3 shows an illustration of how the method of the present invention prevents crosstalk.

FIG. 4 shows a block diagram of a transmitter and a receiver of an embodiment of the present invention.

FIG. 5 shows a sample circuit diagram for a circuit of an embodiment of the present invention.

### DETAILED DESCRIPTION OF THE INVENTION

The below description discloses a system and method for preventing crosstalk in wired communication systems, more specifically in powerline communication systems. It will be clear, however, that the present invention may be practiced without some or all of the specific details disclosed. In other instances, well-known processes, operations, or devices have not been described in detail in order to not unnecessarily obscure the present invention.

While a powerline communication system and certain devices used with such a system are described in the below disclosure, it is to be understood that the present invention is not limited to such systems or devices. The present invention may be used for any wired communication systems where crosstalk is undesirable.

For purposes of the present disclosure, a “receiver” is any device that receives data via a wired communications system, and a “transmitter” is any device that transmits data via a wired communications system. In the example used below, which is not meant to be limiting, a “transmitter” is a hub used for low-voltage powerline carrier systems and a “receiver” is a fixture such as a light fixture, a fan, a light switch, a sensor, or any other device that can be used with a low-voltage powerline carrier system. Multiple transmitters and multiple receivers may be used in the system, which makes it necessary to prevent crosstalk.

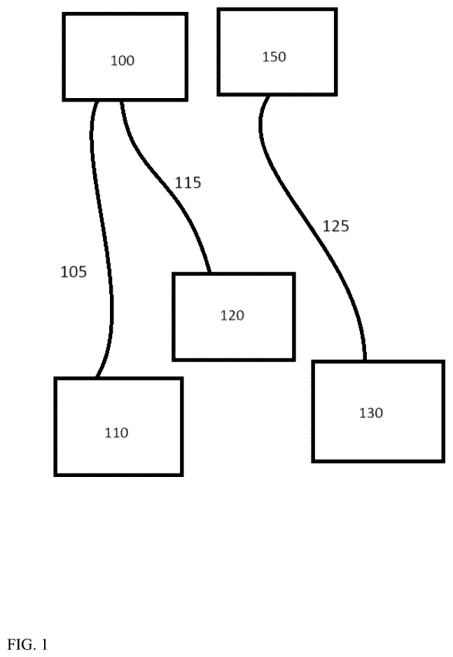

FIG. 1 shows a high-level diagram of the system used to practice the method of the present invention. Transmitter 100 is connected to receivers 110 and 120 with wires 105 and 115. Transmitter 150 is connected to receiver 130 with wire 125. It is important to prevent crosstalk between wire 125 and the other wires 105 and 115, so that receivers 110 or 120 do not get messages meant for receiver 130, and vice versa.

The way that the present invention prevents crosstalk is by pairing each receiver with its corresponding transmitter, and by conducting this pairing in a way that makes crosstalk impossible. This is accomplished by sending a low-frequency bus identification packet from the transmitter to a receiver that is connected to it as an identifier. The bus identification packet is so low-frequency that it is not transmitted via crosstalk, or transmitted in a minimal and highly distorted way. A receiver that is newly connected to the system does not send or receive any data at all until it receives the bus identification packet; once the bus identification packet is received, the receiver pairs with the transmitter that is identified in the packet and only communicates with that transmitter going forward. In the illustration in FIG. 1, transmitter 100 will only be able to communicate with receivers 110 and 120, but not with receiver 130, and transmitter 150 will only be able to communicate with receiver 130, but not with receivers 110 and 120. If any of the receivers happen to get a message from a transmitter to which they are not paired, they will simply ignore it.

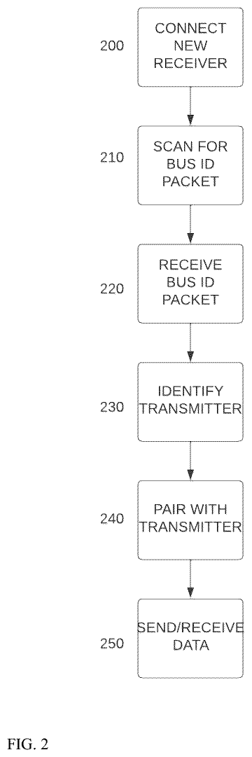

FIG. 2 shows a flowchart describing the process in an embodiment of the present invention. A new receiver is connected to the system 200 by a wired connection with a transmitter. It then scans 210 for a bus identification packet, and does not send or receive any data until it receives this packet. Once a bus identification packet is received 220, the receiver identifies the transmitter 230 that sent the packet, and pairs 240 with that transmitter. After it has paired with the transmitter, it sends and receives data 250 only to that transmitter, and ignores any other data sent by any other transmitter.

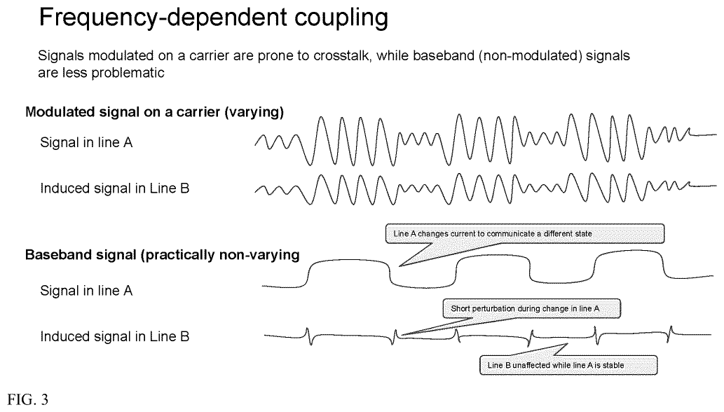

FIG. 3 shows an illustration of how this invention works to prevent crosstalk. A modulated signal on a carrier will easily carry over into a neighboring wire by crosstalk and look just like the original signal in the neighboring wire. A low frequency baseband signal will only cause slight perturbations in the neighboring wire during the changes in voltage, but the perturbations will quickly settle down and disappear. Thus, with a baseband signal, the neighboring wire will either not get any crosstalk at all, or will get a signal that is very different from the original signal. If the baseband signal is overlaid on top of the modulated signal, the modulated signal will carry through by crosstalk and the baseband signal will not.

The bus identification packet is a very low-frequency signal; it is preferably so low-frequency that it effectively acts like a DC signal and does not couple into neighboring wires. In an embodiment, it is a small perturbation of the voltage on the wire. For example, the voltage may be lowered by a few volts for a short time and then return to normal. In an embodiment, the output voltage is 48V; to transmit a bit of information, the voltage may be lowered for one bit-cell time, and then return to 48V. While the initial transition on one wire may induce a brief change in another, only the actual wire changing its voltage will stay at the new level. Any coupled signals will settle out and disappear. If the receiver waits long enough to allow this settling before reading the voltage on the wire, only devices directly connected to the correct wire will see the new level. The frequency of transmission thus depends on the time required to allow this settling.

In an embodiment, the frequency of the signal is approximately 10 Hz, which allows enough time to do this settling. The frequency could be anywhere between 1 Hz to 1 kHz; frequencies higher than 1 kHz will tend to still be transmitted by crosstalk. If the frequency is very low, the signal may take longer to get transmitted, but it will be more robust in a noisy powerline environment. As the frequency gets higher, the signal is transmitted faster, but it is more vulnerable to noise.

In an embodiment, the signal comprises the corresponding hub's identifier (i.e. a MAC address or a similar identifier); the devices that receive that signal then configure themselves to only connect to that hub thereafter. A sample format for the bus identification packet could be as follows:

<start of frame (9 bits high, 1 bit low)><MAC address (48
bits)><metadata(4 bits)><crc(16 bits>

The packet could include a stuff bit high every 8 bits to prevent accidental start frames within the packet. The bus identification packets are then constant length with a known format, so no stop frame will be needed.

It is to be understood that the above is a non-limiting example and that any other bus identification packet format and any other information could also be included in the present invention, as long as the bus identification packet identifies the transmitter in some way.

The bus identification packet can be sent only once for each receiver, when a receiver is first connected to a transmitter. In an embodiment, the bus identification packet can be sent to all the receivers connected to a given transmitter every time a new receiver is connected. In an embodiment, the bus identification packet can be sent more than once, or at regular intervals, to make sure that each receiver is firmly paired with only the transmitter to which it is galvanically connected. For example, it can be sent once a minute. This would enable any receivers that missed the signal to see it again. The transmission frequency is selected to be often enough to keep all devices properly connected but not so often as to waste energy.

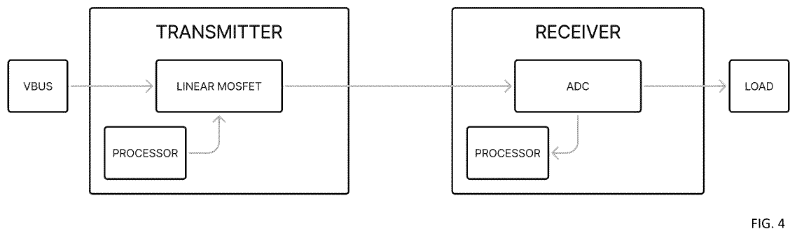

FIG. 4 shows a block diagram for a transmitter and a receiver connected together. As shown, the transmitter has VBus as its input; a processor connected to a linear MOSFET adds data to the output that connects to the receiver. An ADC in the receiver converts the data signal to a digital signal that is then interpreted by the processor in the receiver.

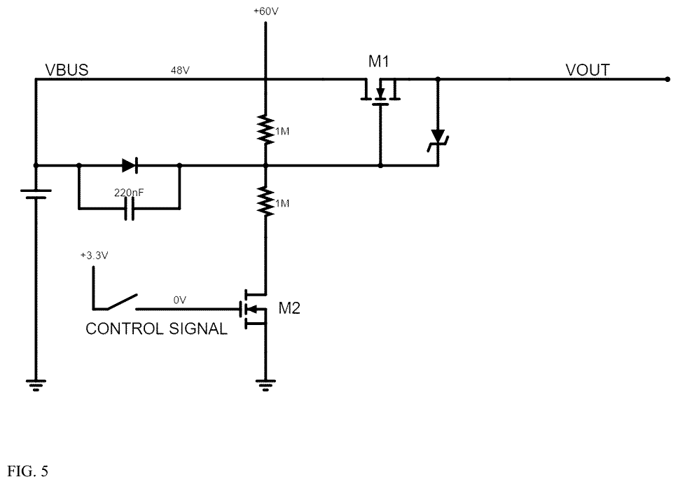

FIG. 5 shows a circuit diagram for a sample circuit that generates this kind of baseband signal in a powerline communication system where the power output is at 48V DC. It will be understood that this is not the only circuit that can generate such a signal, and that this disclosure is not meant to be limiting as to the exact circuit configuration. It is also to be understood that all the values and numbers in this example are arbitrary and not meant to be limiting.

As shown in the Figure, the main power supply VBUS is 48V. There is also a bias power supply 12V above the main power supply, in this case +60V. Additionally, there is a logic level power of 3.3V. An n-channel mosfet M1 is placed in the power path. When the control signal, usually controlled by a microcontroller, is 0V, M2 is in cutoff mode and the Vgs of M1 is greater than Vgs(th) and the mosfet is turned on all the way, causing negligible voltage drop between its drain and source. When the control signal is high and 3.3V is applied to the gate of M2 then Vgs of M1 begins to be less than Vgs(th). At this point M1 enters the linear region, which causes VOUT to drop in voltage when there is a receiver (load) present.

Once the transmitter is paired with a receiver, the two devices can send data back and forth. Since the transmitter identifies itself before sending any data or commands to the receiver, the receiver will be able to determine which transmitter is sending the information. If it receives data or a command from the transmitter to which it is paired, it will react appropriately. For example, if a receiver is a light fixture, it can turn on and off or change color; if a receiver is a sensor, it can send sensor data to the transmitter; and so on. However, if any commands or data appear in the wire via crosstalk from a neighboring wire, the receiver will receive a command or data with an identifier of a transmitter to which it is not paired. It will then ignore the command or data.

The abovedescribed method works with any wired communication systems, and is especially suitable for powerline communication systems as noted above. For a system comprising multiple powerline communication hubs connected to multiple devices, the method of the present invention works well to keep each device communicating only with the hub to which it is galvanically connected.

Exemplary embodiments are described above. It will be understood that the present invention is not limited to the embodiments described above, and that it is only limited by the appended claims.

1. A method of preventing crosstalk in a system comprising a first transmitter, a first receiver, a second transmitter, and a second receiver, wherein the first transmitter is connected to the first receiver by a first wired communication line and the second transmitter is connected to the second receiver by a second wired communication line, comprising:
using the first receiver to scan for a bus identification packet and not transmitting or receiving any data to the first receiver until the bus identification packet is received, wherein the bus identification packet is a low-frequency signal whose frequency is no more than 1 kHz, wherein the bus identification packet comprises identifying information for a transmitter that sends it;
sending a bus identification packet from the first transmitter to the first receiver;
once the bus identification packet is received by the first receiver, pairing the first transmitter and the first receiver so that the first receiver only sends and receives data from the first transmitter and the first transmitter only sends and receives data from the first receiver.

2. The method of claim 1, wherein the identifying information comprises the MAC address for the first transmitter.

3. The method of claim 1, wherein the bus identification packet cannot be transmitted via crosstalk.

4. The method of claim 1, wherein when the bus identification packet is transmitted by crosstalk, it is identifiably different from the bus identification packet in its original wired communication line.

5. The method of claim 1, wherein the bus identification packet is a small perturbation of the voltage on a wired communication line.

6. The method of claim 3, wherein the small perturbation of the voltage comprises lowering the voltage by less than 5V for one bit-cell time.

7. The method of claim 1, further comprising:
using the second receiver to scan for a second bus identification packet and not transmitting or receiving any data to the second receiver until the second bus identification packet is received, wherein the second bus identification packet is a low-frequency signal whose frequency is no more than 1 kHz, wherein the second bus identification packet comprises identifying information for the second transmitter;
sending a second bus identification packet from the second transmitter to the second receiver;
once the second bus identification packet is received by the second receiver, pairing the second transmitter and the second receiver so that the second receiver only sends and receives data from the second transmitter and the second transmitter only sends and receives data from the second receiver.

8. The method of claim 1, wherein the bus identification packet is sent once.

9. The method of claim 1, wherein the bus identification packet is sent more than once.

10. The method of claim 1, wherein the bus identification packet is sent at regular intervals.

11. The method of claim 1, wherein the bus identification packet is sent any time a new receiver or transmitter is added.

12. The method of claim 3, further comprising:
connecting a third receiver to the first transmitter;
using the third receiver to scan for a bus identification packet and not transmitting or receiving any data from or to the third receiver until the third receiver receives a bus identification packet;
sending a third bus identification packet from the first transmitter to the third receiver, wherein the bus identification packet is a low-frequency signal whose frequency is no more than 1 kHz, wherein the bus identification packet comprises identifying information for the first transmitter;
once the third bus identification packet is received by the third receiver, pairing the first transmitter and the third receiver so that the third receiver only sends and receives data from the first transmitter and the first transmitter only sends and receives data from the third receiver.

13. The method of claim 1, wherein the bus identification packet is created by low frequency modulation of the voltage within a range of 5V.

14. A system for preventing crosstalk in a wired communication system, comprising:
a first transmitter;
a first receiver connected to the first transmitter via a first wired connection;
a second transmitter;
a second receiver connected to the second transmitter via a second wired connection;
wherein the first receiver is configured to not send or receive any data until it receives a bus identification packet, wherein the bus identification packet is a low-frequency signal whose frequency is no more than 1 kHz, wherein the bus identification packet comprises identifying information for a transmitter that sends it;
wherein the first receiver is configured to pair with any transmitter that sends a bus identification packet to the first receiver;
wherein the second receiver is configured to not send or receive any data until it receives a bus identification packet, wherein the bus identification packet is a low-frequency signal whose frequency is no more than 1 kHz, wherein the bus identification packet comprises identifying information for a transmitter that sends it;
wherein the second receiver is configured to pair with any transmitter that sends a bus identification packet to the second receiver.

15. The system of claim 14, wherein the first wired connection and the second wired connection are powerline communication systems connections.

16. The system of claim 14, wherein the first transmitter and the second transmitter are powerline communication hubs.
